(19) United States
(12) Patent Application Publication
(10) Pub. No.: US 2006/0031657 A1
(43) Pub. Date: Feb. 9, 2006

(54) Storage control device having restoration function to initial status, control method of storage device, and program

(75) Inventors: Takashi Ooyama, Kawasaki (JP); Akihiko Sasaki, Kawasaki (JP); Kouichi Murakami, Nagoya (JP); Takaya Koshinuma, Tokyo (JP); Masanori Kawahara, Kawasaki (JP)

Correspondence Address: Patrick G. Burns, Esq.;GREER, BURNS & CRAIN, LTD., Suite 2500, 300 South Wacker Drive, Chicago, IL, 60606, US

(73) Assignee: FUJITSU LIMITED

(21) Appl. No.: 11/072,676

(22) Filed: Mar. 4, 2005

Related U.S. Application Data
(63) Continuation of application No. PCT/JP02/12374, filed on Nov. 27, 2002.

(51) Int. Cl. G06F 12/10

(52) U.S. Cl. 711/203; 711/165

(57) ABSTRACT

A storage device including an initial data storage area storing initial data, an updated data storage area storing updated data corresponding to the initial data, and a designation area designating either the initial data storage area or the updated data storage area to be readout. A storage control device comprises a write writing data in the updated data storage area, a re-write unit re-writing the designation area in which information for reading the initial data storage area is set in the initial stage into the setting of reading the updated data storage area when writing into the updated data storage area occurs, an initializing unit re-writing the information in the designation area to the setting of reading of the initial data, and a selection unit selecting to read either the initial data storage area or the updated data storage area when reading the data.

This is a continuation of Application PCT/JP2002/12374, filed on Nov. 27, 2002.

### BACKGROUND OF THE INVENTION

1. Technical Field

The present invention relates to a storing technique and a recording technique in a computer and the like.

2. Background Art

The present invention is applied to an information apparatus such as a personal computer or the like, which has a storage device such as a fixed magnetic disc device, a non-volatile semiconductor storage device, or the like. The information apparatus is sold with a computer program such as an operating system, an application software, and the like being recorded in advance in the storage device. Those information apparatuses require a function for restoring to an initial status when shipped from a factory, for example, because of a trouble during usage and the like.

FIG. 1 shows the storage configuration of the storage device, such as the fixed magnetic disc device or the like, which the information apparatus such as the personal computer or the like has. The storage device of the information apparatus is sold such that the computer program such as the operating system, the application software, and the like is recorded therein in advance when shipped from the factory, as shown in 700 of FIG. 1. Also, in the information apparatus, a setting data is added to the computer program, and stored as initial data 702 in some area on the fixed magnetic disc.

A program permitted to be written and setting data are mixed in the initial data 702. Thus, in association with the usage of the program or the update to a new program by a user, an area written from the initial status and the area still kept at the initial status are mixed as shown in 710 of FIG. 1.

There is a case that it is desired that the initial data be restored for the information apparatus to return to the initial status at the time of the factory shipment because of a trouble during the usage or the like, for example. As a method of storing this initial data, a method which simply disables the writing to the initial data area is considered. However, the method which disables the writing to the fixed magnetic disc and the like cannot be actually applied. This is because the update of the program and the update of the setting data become impossible.

In the conventional technique, in order to restore the fixed magnetic disc from the under-use status to the initial status, a method of storing a copy of the initial data in a different recording medium such as CD-ROM or the like and copying is proposed. Also, as indicated in Japanese Utility Model Application No. 10-6864, JP-A 2000-181772, and the like, a function of holding the copy of the initial data in an area protected on the magnetic disc, using a software for restoration, and then copying the initial data to a predetermined area, and consequently restoring to the initial status is proposed.

Also, as the conventional technique in a non-volatile semiconductor storage device such as a flash memory and the like, there are JP-A 63-228323 and JP-A 5-216654. In the method of JP-A 63-228323, the storage area is divided into an initial data area, a map area, and a change data area. At a time of writing, an address of a change portion for the initial data is written to the map area, and a change data is written to the change data area. At a time of reading, after all of the initial data are once read, the map area and the change data are sequentially read to overwrite the initial data.

Also, JP-A 5-216654 discloses a technique which uses two flash memories, always stores an old program in one flash memory, and consequently protects a start program from being lost when the flash memory is rewritten.

As described in the conventional techniques, the method of copying from the initial data storing source such as the CD-ROM, the flash memory, or the like, or copying from another area to a different area on the storage device requires a long time of several minutes to several tens of minutes for a work to restore to the initial status. Then, during the work, the user cannot use the computer.

Also, the method of JP-A 63-228323 is designed such that after the initial data is once read, the change data is read to modify the initial data. Thus, the consideration with regard to a high speed processing is not sufficient.

### SUMMARY OF THE INVENTION

The present invention has been made in view of the problems in the conventional techniques. That is, an object of the present invention is to reduce the time required to restore a computer to the initial status at the time of a shipment as much as possible.

The present invention adopts the following means in order to solve the problems. That is, the present invention provides a storage control device controlling a storage device which includes: an initial data storage area storing an initial data; an updated data storage area storing an updated data related to the initial data; and a designation area designating any of the initial data storage area and the updated data storage area as a reading target, the storage control device including:
a writing section writing data to the updated data storage area;
a rewriting section rewriting the designation area, in which information for reading the initial data storage area is set at an initial time point, to a setting of reading the updated data storage area, when a writing to the updated data storage area occurs;
an initializing section rewriting the information in the designation area to the setting of reading the initial data;
a selecting section selecting any of the initial data storage area and the updated data storage area to be read when the data is read; and
a reading section reading the updated data storage area or the initial data storage area in accordance with the selection of the selecting section.

The initial data is the data or/and the computer program stored when the storage device or the system including the storage device is shipped from, for example, a factory. Also, the updated data is the data to add or change, for example, the data, the computer program, and the like. The updated data is stored in a storage area corresponding to the initial data. The storage area corresponding to the initial data implies, for example, the storage area that can be singly determined by a predetermined process from the storage area of the initial data.

The storage control device rewrites a designation area, in which the information for reading an initial data storage area is set at an initial time, to the information for reading an updated data storage area when the writing to the updated data storage area occurs. Then, the storage control device selects one of the initial data storage area and the updated data storage area when the data is read, and reads the updated data storage area or the initial data storage area in accordance with the selection.

Thus, according to the present invention, in situation that the initial data storage area is maintained, combined data of the initial data and the updated data can be stored. Also, the increase in the read time to read the combined data of the initial data and the updated data can be reduced to the range of the data read time of the designation area.

Then, the storage control device, since having an initializing section rewriting the information of the designation area to the setting of reading of the initial data, can initialize the storage device in the writing time to the designation area.

Preferably, in the storage device, the initial data storage area and the updated data storage area may be alternately arranged and stored for each predetermined storage unit, and
the reading section may read at least any of the data in the initial data storage area and the data in the updated data storage area which are alternately arranged.

Preferably, the storage management device may further have a logical address managing section relating the initial data storage area and the updated data storage area to the same logical address.

Preferably, the storage device may be a disc type storage device, and the predetermined storage unit may be one or more tracks of the disc. Thus, for example, the pair of tracks of the disc can be consecutively read, thereby reducing the access time associated with the seeking of the disc.

Preferably, the storage device may have any one or more of the initial data storage area, the updated data storage area, and the designation area on the non-volatile semiconductor memory.

Also, the present invention may be the method in which the computer or the other device, machine, or the like executes any of the processes. Also, the present invention may be the program which enables any of the functions, steps, or processes to be attained in the computer or the other device, machine, or the like. Also, the present invention may be a configuration such that the program is recorded in the recording medium which can be read by the computer or the other device, machine, or the like.

### BRIEF DESCRIPTION OF THE DRAWINGS

FIG. 1 is a data storage example on a fixed magnetic disc device in which a program permitted to be written and data are mixed;

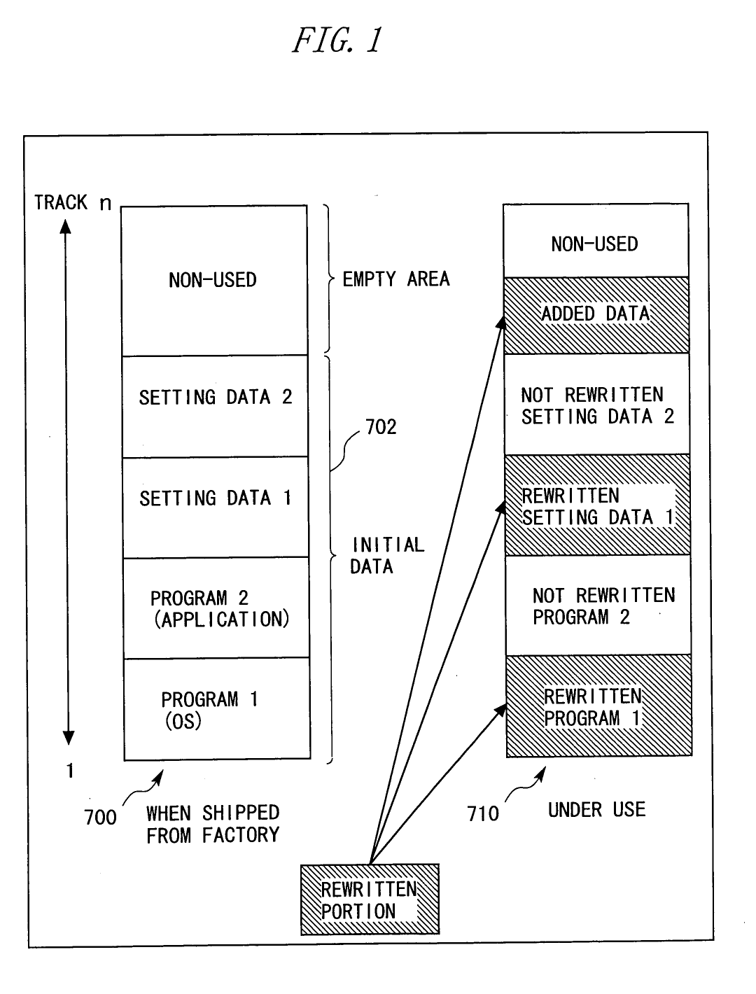

FIG. 2 is a configuration example of a fixed magnetic disc device according to a first embodiment;

FIG. 3 is an example of a data storage format of a fixed magnetic disc device having a conventional initial status restoration function;

FIG. 4 is an example of a restoring operation to restore to an initial status by using the conventional initial status restoration function;

FIG. 5 is an example of a data storage format of an information apparatus according to the first embodiment;

FIG. 6 is a flowchart showing a switching operation of a logical address→track number conversion circuit;

FIG. 7 is an example of a storage format of an address conversion information;

FIG. 8 is a modified example 1 of the data storage format of the fixed magnetic disc device having the initial status restoration function;

FIG. 9 is a modified example 2 of the data storage format of the fixed magnetic disc device having the initial status restoration function;

FIG. 10 is a modified example of the fixed magnetic disc device;

FIG. 11 is an example of a data storage format for the initial status restoration function, in an information apparatus including a flash memory and the like;

FIG. 12 is an example of a data storage format when two flash memories are used;

FIG. 13 is an example of an address conversion information storage format in a case of an application to the flash memory or the like;

FIG. 14 is an example (initial status) of an address conversion method in the case of the application to the flash memory or the like;

FIG. 15 is an example (writing operation 1) of the address conversion method in the case of the application to the flash memory or the like;

FIG. 16 is an example (writing operation 2) of the address conversion method in the case of the application to the flash memory or the like; and

FIG. 17 is an example (status under use) of the address conversion method in the case of the application to the flash memory or the like.

### DETAILED DESCRIPTION OF THE INVENTION

The preferable embodiment according to the present invention will be described below with reference to the drawings.

### First Embodiment

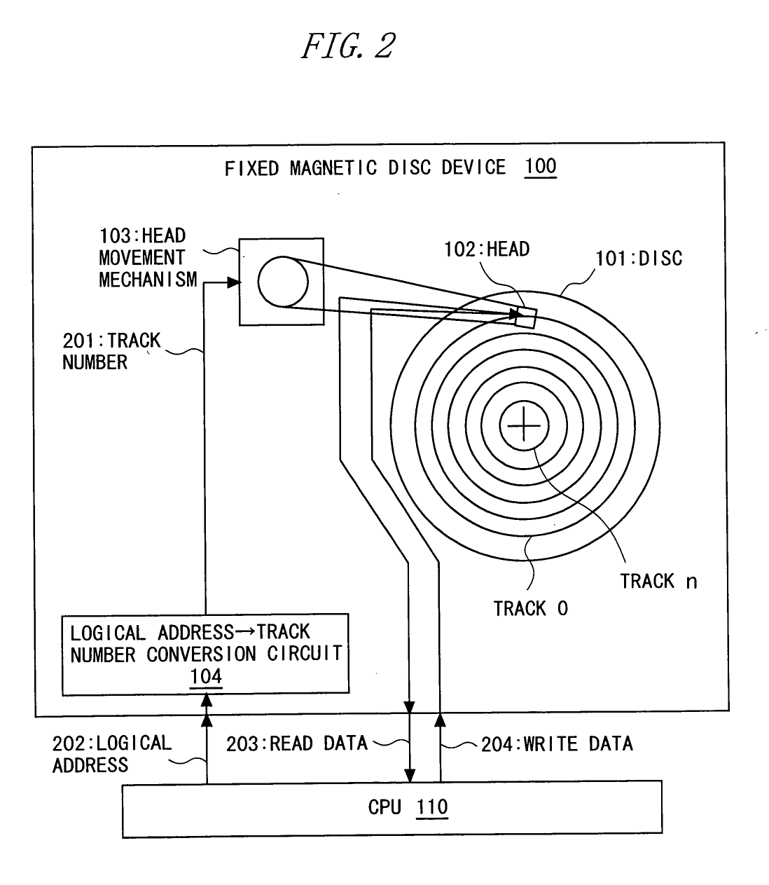

An information apparatus according to the first embodiment of the present invention will be described below in accordance with the drawings of FIG. 2 to FIG. 10.

<Function Schema>

The information apparatus is the information apparatus having a fixed magnetic disc device. The fixed magnetic disc device stores an operating system (hereafter, referred to as OS), various application programs and an initial data set at the time of factory shipment.

In the conventional information apparatus, the initial data is once copied to a predetermined area and the conventional information apparatus is used in situation that the original initial data is stored, in many cases. Thus, by again copying the stored initial data, the information apparatus can be restored to the initial status at the time of the factory shipment.

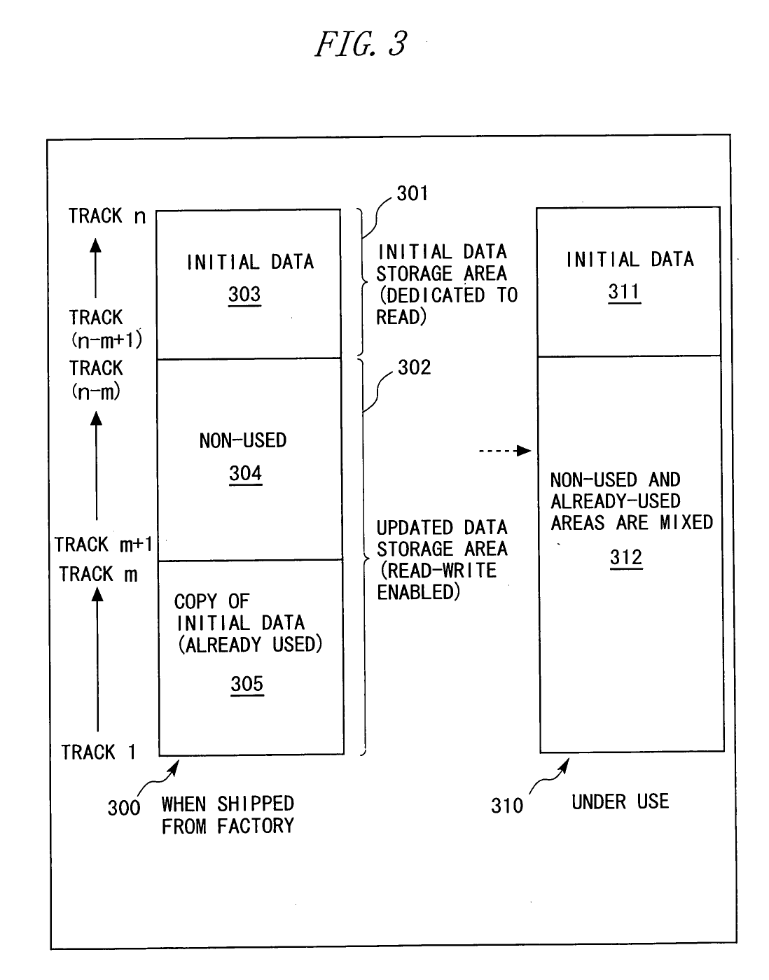

FIG. 3 is an example of a data storage format of a fixed magnetic disc device having a conventional initial status restoration function, as mentioned above. A storage status 300 at the time of the factory shipment of a fixed magnetic disc is indicated on the left side of FIG. 3. At the time of the factory shipment, initial data 303 is stored in an area from tracks n−m+1 to n, and a copy 305 of the initial data 303 is stored in an area from tracks 1 to m. Also, at the time of the factory shipment, an area from tracks m+1 to n−m is a non-used area 304. The copy 305 of the initial data 303 and the non-used area 304 constitute an updated data storage area 302 where the reading and the writing are possible. The storage status is referred to as the initial status of the fixed magnetic disc.

In accordance with the usage of the information apparatus having the fixed magnetic disc device, the copy 305 of the initial data is rewritten. Thus, in the information apparatus, once it is used by a user, the storage status of the fixed magnetic disc becomes a status 310 shown on the right side of FIG. 3.

That is, at the status 310 during the usage of the information apparatus, initial data 311 is identical to original initial data 301. However, the copy 305 of the initial data is rewritten and becomes at a status 312 where the non-used and used areas are mixed.

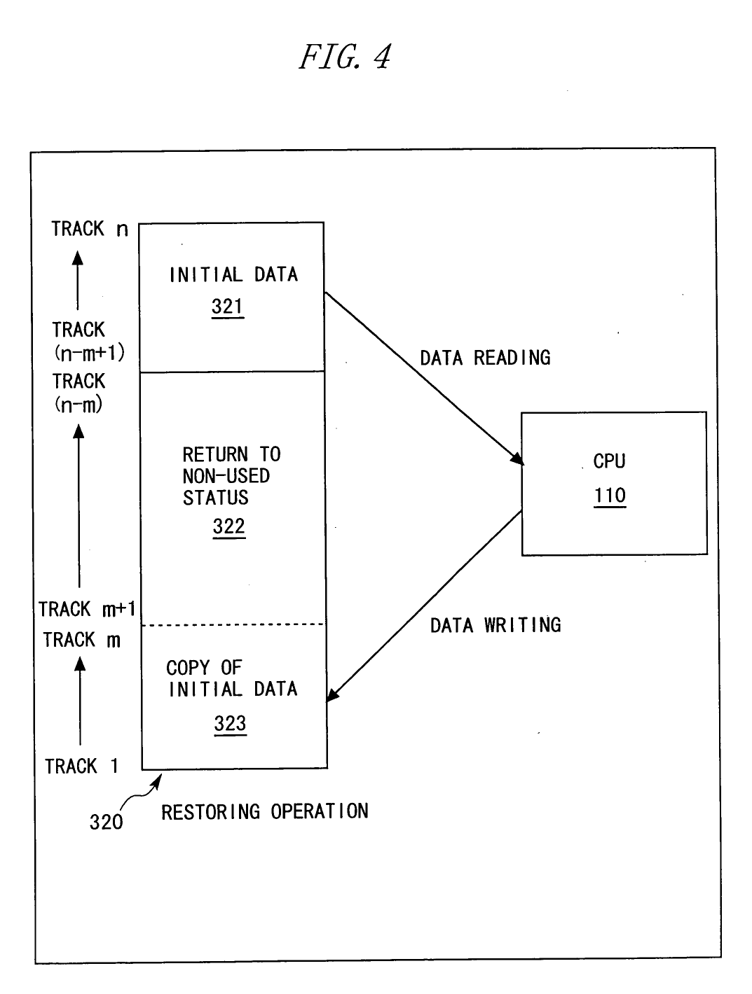

FIG. 4 is an example of a restoring operation for restoring the status 310 during the usage of the information apparatus of FIG. 3 to the initial status by using the conventional initial status restoration function. In FIG. 4, initial data 321 (the same content as the initial data 303 or 311 shown in FIG. 3) stored in the area from the track n−m+1 to the track n is read by a CPU 110 and copied to the area from the tracks 1 to m. As a result of this copy, a copy 323 of the initial data is generated (this is identical to the copy 305 of the initial data shown in FIG. 3). Moreover, the area from the tracks m+1 to n−m is returned to an area 322 of a non-used status.

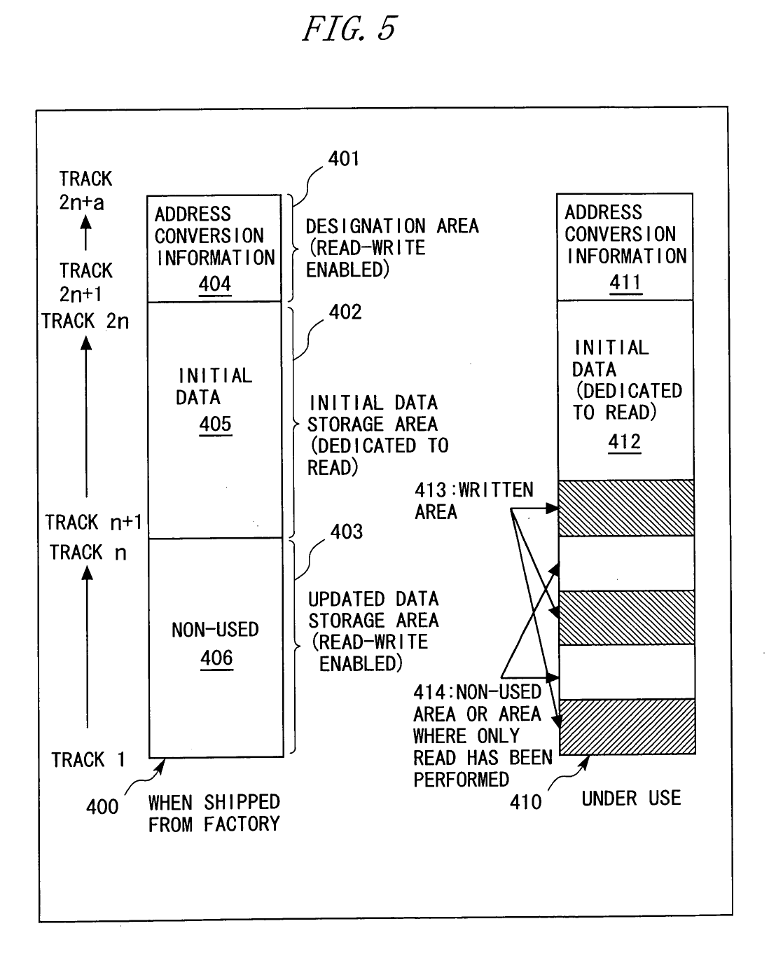

In the information apparatus of this embodiment shown in FIG. 5, the initial data is not used after copied, and in accordance with the following procedure, the initial data is used at the stored status. That is, in this information apparatus, an initial data storage area to be mapped to the same logical address as the updated data storage area is provided on the fixed magnetic disc.

Moreover, a designation area for storing address conversion information is provided on the fixed magnetic disc. The address conversion information designates the reading from the updated data storage area or the reading from the initial data storage area.

In accordance with the designation of the address conversion information, till the time when occurring the writing of first data from time of the initial status, the information apparatus reads the data from the initial data storage area. Then, after the first data is written, the address conversion information is changed so and the information apparatus get to read the data from the updated data storage area.

In this way, since the reading target area is switched in accordance with the address conversion information, the process for copying the initial data becomes unnecessary in this information apparatus. Also, even after the initial data is once rewritten, the time required to restore to the initial status at the time of the original factory shipment is set to approximate 0 (the time required to switch the reading target).

<Hardware Configuration>

FIG. 2 is the configuration example of the fixed magnetic disc device which embodies the present invention. The CPU 110 transmits a logical address 202 prior to writing or reading data. Then, a logical address→track number conversion circuit 104 converts a logical address into a track number 201, and a head movement mechanism 103 moves a head 102 to a position of the track number 201 of a disc 101.

The usual fixed magnetic disc device singly determines a track number corresponding to one logical address. Thus, the fixed magnetic disc device having the conventional initial status restoration function stores the initial data as shown in FIG. 3, uses a program of the external CPU 110 as shown in FIG. 4 to copy the initial data, and consequently attains the initial status restoration function.

<Address Conversion Process>

FIG. 5 shows the data storage format of the information apparatus in this embodiment. The information apparatus is configured by dividing the area of the fixed magnetic disc into three areas (areas 401, 402, and 403) such as a status 400 at the time of the factory shipment.

Then, address conversion information 404 is recorded in one (the area 401 from the track numbers 2n+1 to 2n+a) among the three areas, and initial data 405 is recorded in another one (the area 402 from the track numbers n+1 to 2n). Also, the remaining one (the area 403 from the track numbers 1 to n) is reserved at the lead portion of the fixed magnetic disc, as a non-used area 406 having the same size as the initial data 405.

The right side of FIG. 5 shows the storage status in the case of an occurrence of a write request. In the case of the occurrence of the write request, in the situation that initial data 412 in the area from the track numbers n+1 to 2n is stored, the data is written to the area from the track numbers 1 to n, and an already-written area 413 and an area 414 which is non-used or on which only reading is performed are generated. An address conversion information 411 holds the information as to whether or not the writing is already performed on the respective tracks from the track numbers 1 to n.

If a read request occurs in the fixed magnetic disc at the storage status, the already-written track is read from the area from the track numbers 1 to n, and the track of the non-used area is read from the initial data 412 in the area from the track numbers n+1 to 2n.

That is, the logical address→track number conversion circuit 104 in this information apparatus switches the track, which is used between the track number in the updated data storage area 403 and the track number in the initial data storage area 402, in accordance with the address conversion information 404.

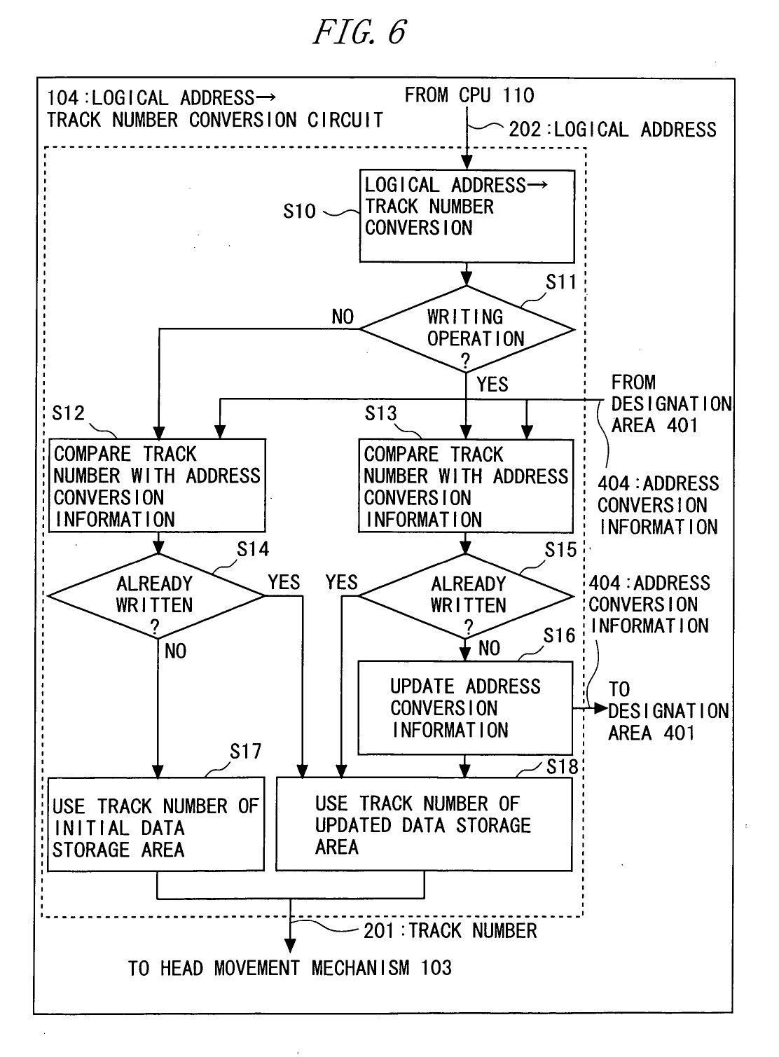

FIG. 6 shows the switching operation of the logical address→track number conversion circuit 104. The logical address transmitted from the CPU 110 is first converted into the track number of the updated data storage area in the logical address→track number conversion circuit 104 (S10).

Then, the logical address→track number conversion circuit 104 judges whether an access is a writing operation or a reading operation (S11).

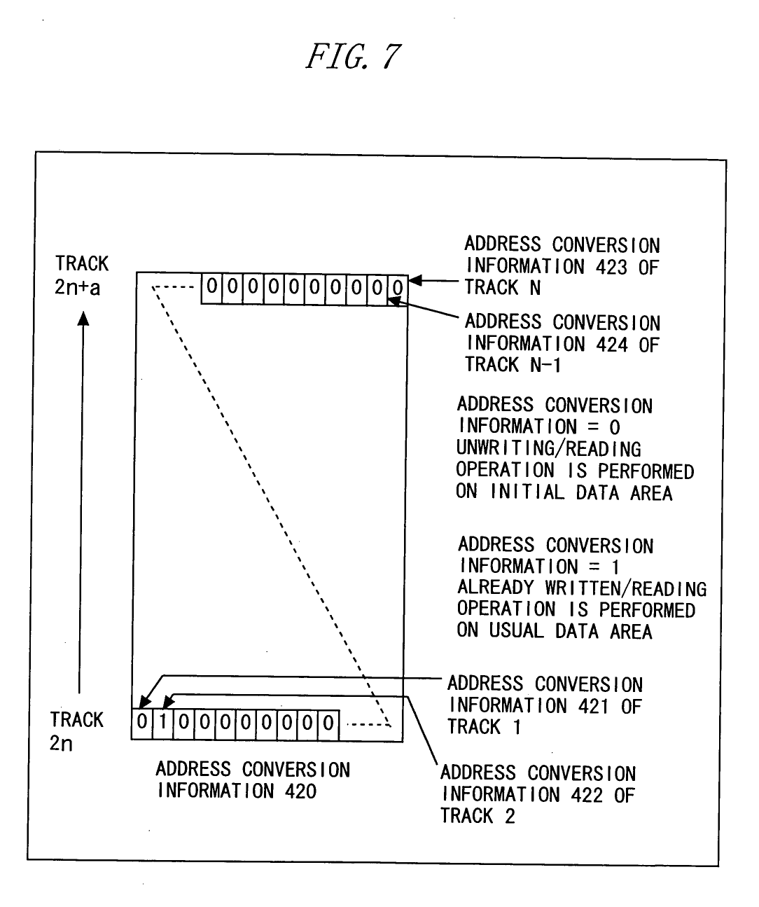

In the case of the writing operation, its track number is transmitted to the head movement mechanism 103, and the usual track number is used to write the data (S18). Here, if the first writing is performed on an appropriate track which is in the initial status (case of NO at S15), as shown in FIG. 7, the address conversion information of the appropriate track is rewritten to the already-written status (S16).

Also, in the case of the reading operation, the logical address→track number conversion circuit 104 refers to the address conversion information (S12) and judges whether or not the track is already written (S14).

If the track of the reading target is already written, the logical address→track number conversion circuit 104 transmits the track number of the updated data storage area in its original status (S18). On the other hand, if the writing is not still performed on the track of the reading target, the logical address→track number conversion circuit 104 transmits the track number of the initial data storage area (S17).

FIG. 7 shows the detail of address conversion information 420. As already described in FIG. 5, in this embodiment, the address conversion information 420 is stored in the area from the tracks 2n+1 to 2n+a of the fixed magnetic disc. In the address conversion information 420, one bit is provided for the respective tracks (the track numbers 1 to n) of the access target.

Thus, sequentially from the lead bit of the track 2n+1, the address conversion information 420 of each track of the track numbers 1, 2, . . . is stored. Then, in the case where the bit of the address conversion information 420 corresponding to the track is set to 0, the writing is not still performed on the track, and the track of the initial data storage area is accessed in response to the reading request.

Also, in the case where the bit of the address conversion information 420 corresponding to the track is set to 1, the writing is already performed on the track, and the track of the updated data storage area is accessed in response to the reading request.

In order to restore the fixed magnetic disc to the initial status, all of the address conversion information 420 of FIG. 7 may be set to 0. In this way, this information apparatus can restore the fixed magnetic disc to the initial status within the time in which the data of the number of the bits corresponding to the number of all tracks is cleared.

### MODIFIED EXAMPLE 1

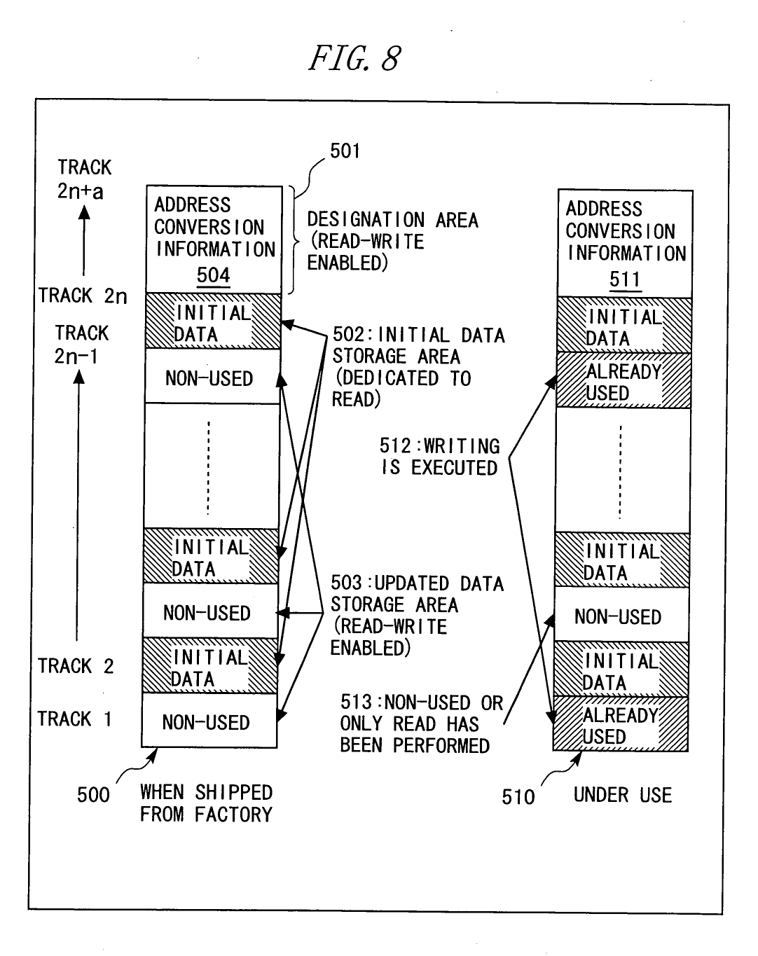

FIG. 8 shows another example of the data storage format of the fixed magnetic disc device having the initial status restoration function. As compared with the configuration of the storage area of FIG. 5, in FIG. 8, the initial data storage area and the updated data storage area are alternately arranged in the adjacent tracks.

That is, at an initial status 500 at the time of the factory shipment (on the left side of FIG. 8), among the tracks of the track numbers 1 to 2n, the odd tracks are non-used, and the initial data are stored in the even tracks.

Also, for example, when the initial data in the track 2 is changed, the data after the change is stored in the track 1 instead of the track 2. Typically, when the initial data in the track 2m is changed, the data after the change is stored in the track 2m−1 instead of the track 2m.

Under the data configuration, if the reading request to the track 2m−1 occurs, the data in the track 2m−1 and the track 2m are continuously read to a read buffer area (not shown). After the reading operation, the logical address→track number conversion circuit 104 in this information apparatus may select any of the data in the track 2m−1 and the data in the track 2m on the read buffer in accordance with the address conversion information.

Due to the reading operation, in addition to the protection of the initial data, the head movement distance in reading the data where the already-written track and the non-written track (the track of the initial data) are mixed can be made shorter, thereby executing the reading operation at a high speed.

### MODIFIED EXAMPLE 2

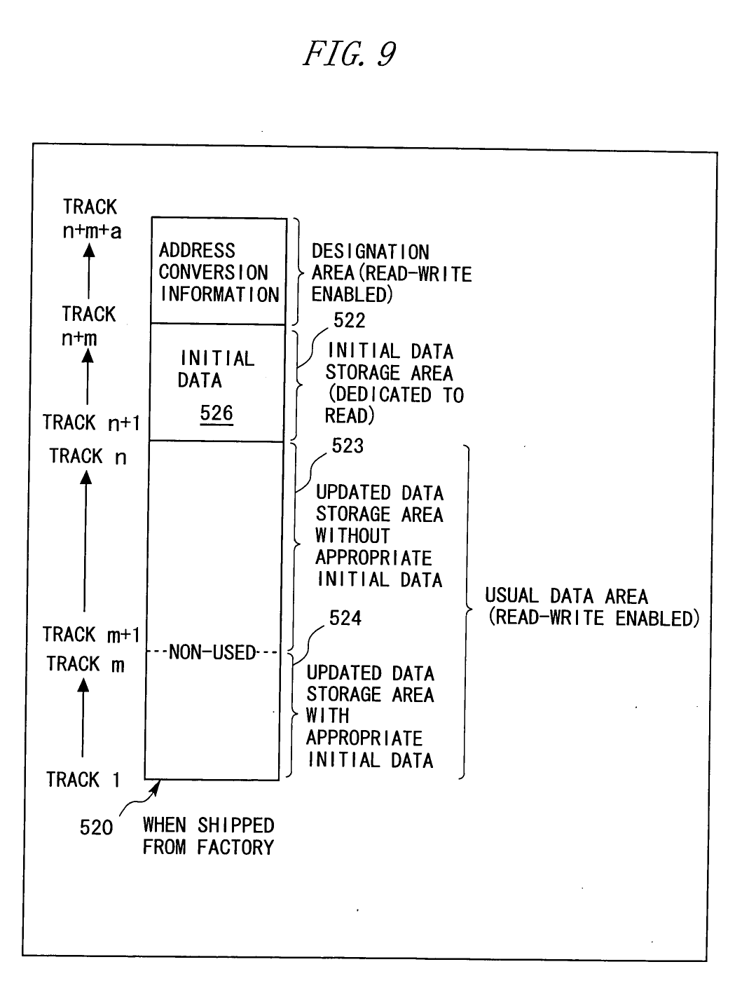

FIG. 9 shows another example of the data storage format of the fixed magnetic disc device having the initial status restoration function. In the example shown in FIG. 5, the initial data storage area 402 and the updated data storage area 403 are equal in size. Thus, in the example shown in FIG. 5, the area of the fixed magnetic disc is occupied by the designation area 401, the initial data storage area 402, and the updated data storage area 403 for storing the data in which the initial data is changed. Hence, the area that can be used by the user is not left.

However, typically, the size of the initial data usually occupies only part of the entire storage area. For example, m<<n is established with regard to the number of tracks n in the updated data storage area and the number of tracks m in the initial data storage area. Thus, as shown in FIG. 9, it is enough to be able to reserve an updated data storage area 524 (the track numbers 1 to m) corresponding to the size (the number of tracks m) of initial data 526 and store the data in which the initial data 526 is rewritten.

In this case, since the address conversion is not performed on the area 523 on and after the track m+1, this area 523 can be opened as a user area.

### MODIFIED EXAMPLE 3

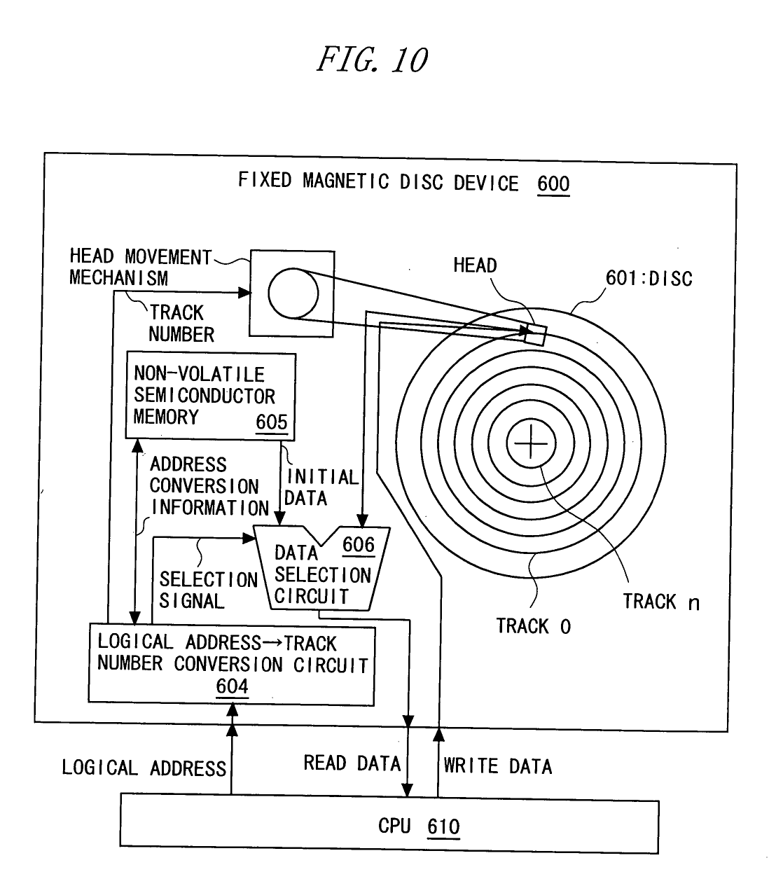

FIG. 10 shows another configuration example of the fixed magnetic disc device. In the example of FIG. 2, the address conversion information is stored on the same disc as the data. However, the embodiment of the present invention is not limited to the configuration.

A fixed magnetic disc device 600 shown in FIG. 10 has a non-volatile semiconductor memory 605, as compared with the fixed magnetic disc device of FIG. 2. Since the address conversion information is recorded in the non-volatile semiconductor memory 605, the time necessary for the address conversion is made shorter.

Moreover, in the fixed magnetic disc device 600, the initial data is recorded in the non-volatile semiconductor memory 605 so that the time required to read the data is made shorter.

In the fixed magnetic disc device 600, when the data is read, a CPU 610 outputs a logical address to a logical address→track number conversion circuit 604. Then, the logical address→track number conversion circuit 604 converts the logical address into a track number.

Moreover, the logical address→track number conversion circuit 604 accesses the non-volatile semiconductor memory 605 and judges whether or not the writing is already performed on the track. Then, the logical address→track number conversion circuit 604 outputs a selection signal to a data selection circuit 606.

The data selection circuit 606 switches and outputs the read data from the non-volatile semiconductor memory 605 and the read data from a fixed magnetic disc 601 in accordance with the selection signal.

It is noted, when the address conversion information is stored in the non-volatile semiconductor memory 605 and the initial data is stored in the fixed magnetic disc 601, the read data may be switched between the track of the initial data and the track of the write data. Its procedure is equal to the case shown in FIG. 6.

Also, as shown in FIG. 8, when the track of the initial data and the track of the write data are alternately arranged, the data selection circuit 606 may be designed so as to select any data of two continuous data read in a read buffer (not shown).

### Second Embodiment

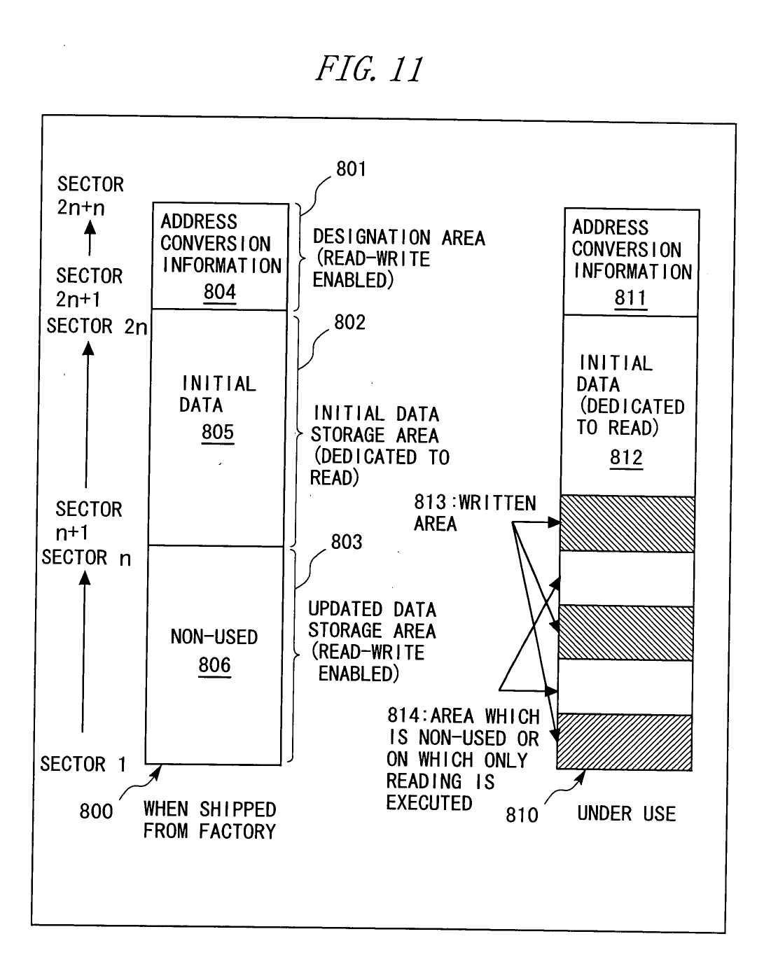

An information apparatus according to the second embodiment of the present invention is explained in accordance with the drawings in FIG. 11 to FIG. 16. In the first embodiment, the configuration example is explained in which the information apparatus having the fixed magnetic disc device is restored to the initial status at the time of the factory shipment in the short time.

In this embodiment, a configuration example is explained in which an information apparatus having a non-volatile semiconductor storage device such as a flash memory and the like is restored to the initial status at the time of the factory shipment in a short time (a time for clearing the address conversion information).

FIG. 11 is the example of the data storage format for the initial status restoration function in the information apparatus having the flash memory and the like. FIG. 11 shows an example in which one flash memory is used and a size (number of sectors n) of an initial data storage area 802 and a size (number of sectors n) of an updated data storage area 803 are equal.

FIG. 11 corresponds to FIG. 5 in the first embodiment and shows sector numbers 1, n, 2n, 2n+a, and the like, instead of the track numbers. However, although the physical recording medium is changed from the fixed magnetic disc to the flash memory, the logical storage configuration is similar to the case of FIG. 5.

That is, as shown on the left side of FIG. 11, at an initial status 800 at the time of the factory shipment, the updated data storage area 803 from the sectors 1 to n are assumed to be a non-used area 806, initial data 805 is stored in the initial data storage area 802 from the sectors n+1 to 2n, and address conversion information 804 is stored in a designation area 801 from the sectors 2n+1 to 2n+a.

Also, as shown on the right side of FIG. 11, at a status 810 under use of this information apparatus, in situation that an initial data 812 (the same content as the initial data 805) is stored, an already-written area 813 and an area 814 which is non-used (or on which only reading is performed) are mixed.

In this way, even in the case of the flash memory, the operation is carried out similarly to the case of the fixed magnetic disc device shown in FIG. 5. However, differently from the fixed magnetic disc device in which data is managed in units of tracks, in the flash memory, data is managed in units of sectors which is a minimum erasing unit.

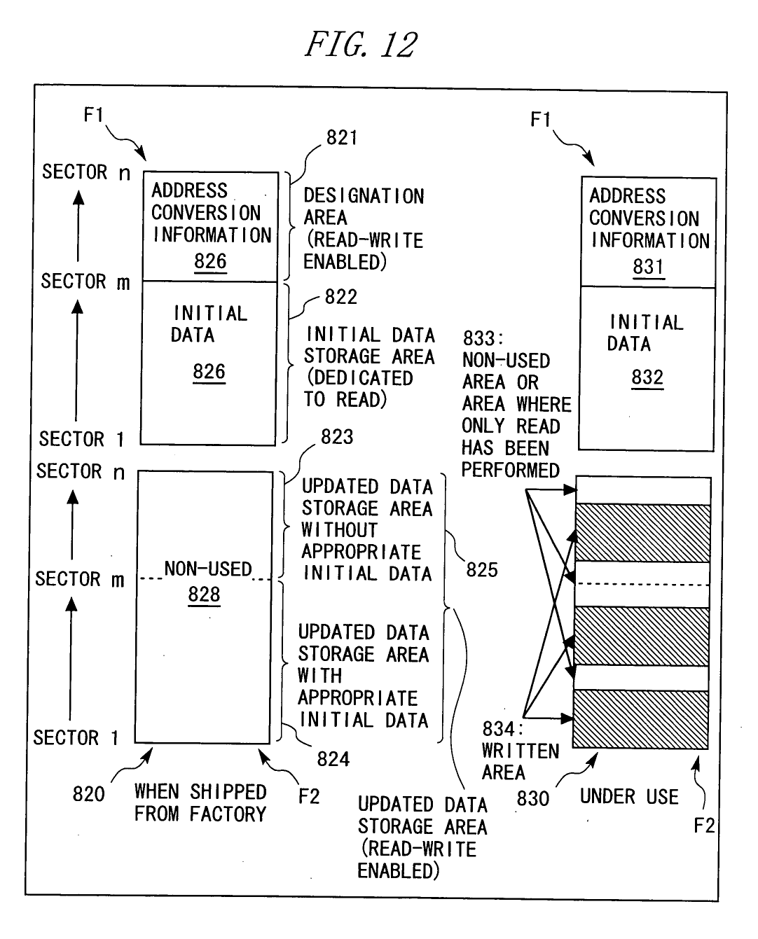

FIG. 12 is an example of the storage configuration in which two flash memories (F1 and F2) are used and a size of the initial data storage area and a size of the updated data storage area are different. That is, at an initial status 820 at the time of the factory shipment, initial data 827 is stored in an initial data storage area 822 (the sectors 1 to m of the first flash memory F1), and address conversion information 826 is stored in a designation area 821 (the sectors m+1 to n of the first flash memory F1). On the other hand, an updated data storage area 825 (the sectors 1 to n of the second flash memory F2) is a non-used area.

The non-used area 828 is composed of: an updated data storage area 823 without any appropriate initial data; and an updated data storage area 824 with the appropriate initial data.

On the other hand, at an under-use status 830, the updated data storage area 824 with the appropriate initial data is composed of an already-written area 834 and an area 833 which is non-used (or on which only reading is performed). However, the sectors (the updated data storage area 823 without any initial data) other than the sectors 1 to m in the updated data storage area 825 are the area that can be used by the user. This configuration is similar to the case explained in FIG. 9.

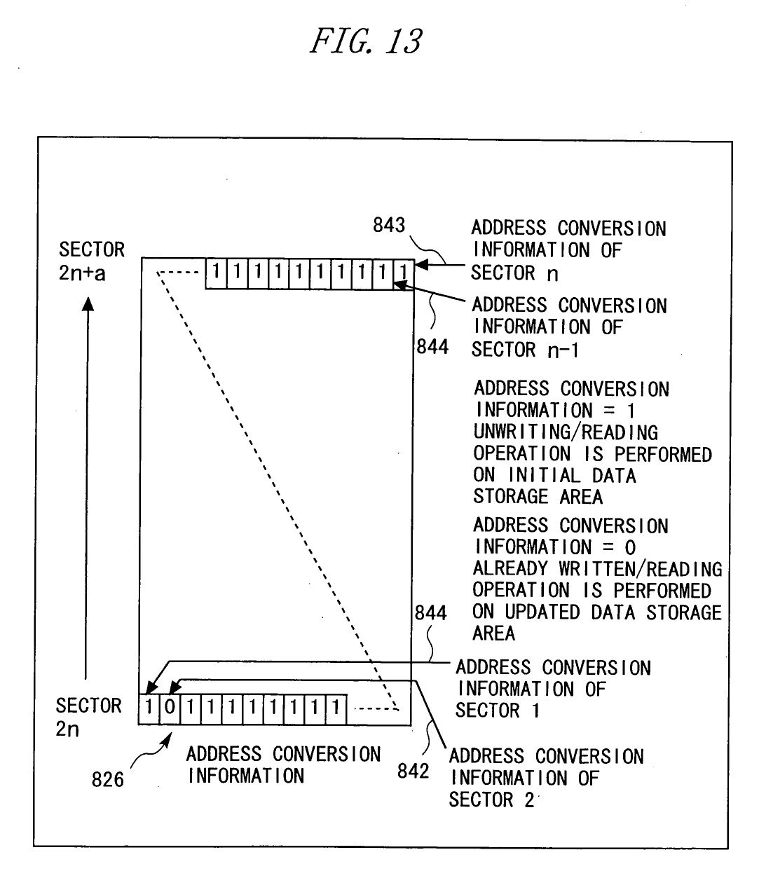

FIG. 13 is an example of the storage format of the address conversion information in the case of the application to the flash memory or the like. The typical flash memory is designed such that all data bits become “1” at a time of erasing. As shown in FIG. 13, since “1” implying an erasure status is assigned to a reading indication to the initial data storage area, the restoring operation to the initial status is carried out only by the erasing operation for the address conversion information area which is part of the entire capacity of the flash memory.

That is, the case of the address conversion information=1 is the case that the writing is not executed or only reading operation is executed. Then, the reading operation is performed on the initial data storage area. Also, the case of the address conversion information=0 is the case that the writing is already executed. Then, the reading operation is performed on the updated data storage area. Thus, similarly to the first embodiment, the operation for the data area is not required at all. Hence, the restoring operation is instantly executed.

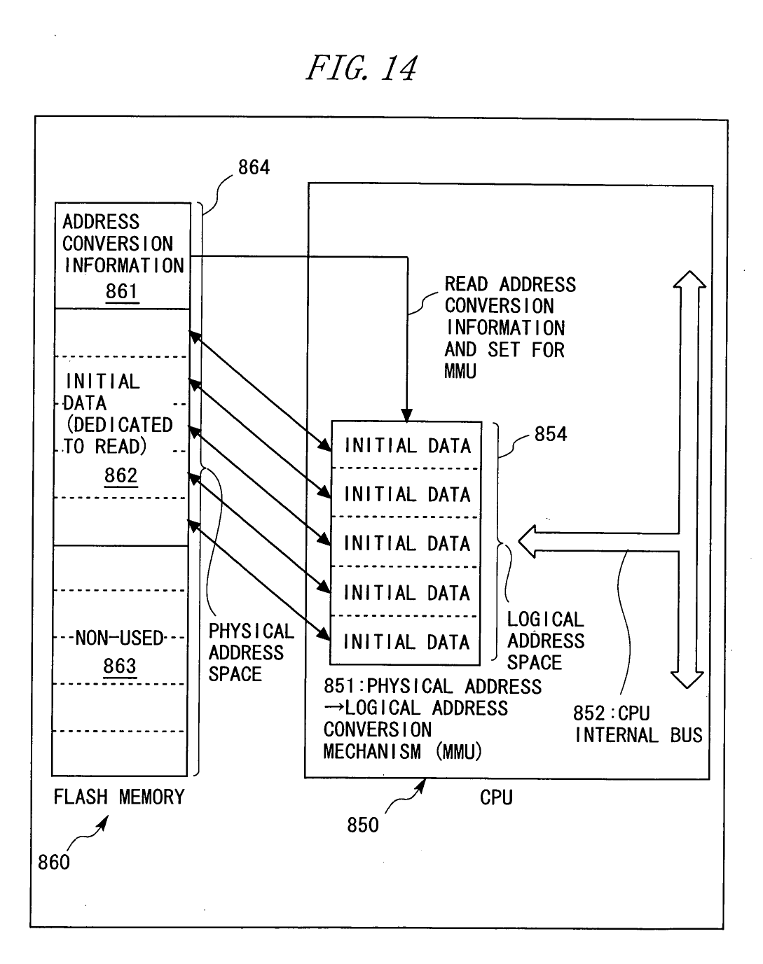

FIG. 14 shows the initial status in the case of the application to the flash memory and the like. In FIG. 14, the information apparatus has a CPU 850 and a flash memory 860.

The CPU 850 reads address conversion information 861 from the flash memory 860 and sets a physical address logical address conversion mechanism (MMU) 851 in the CPU 850.

At the initial status, a physical address pointing out all initial data 862 is mapped to a logical address space 854 viewed from an internal bus 852 of the CPU 850.

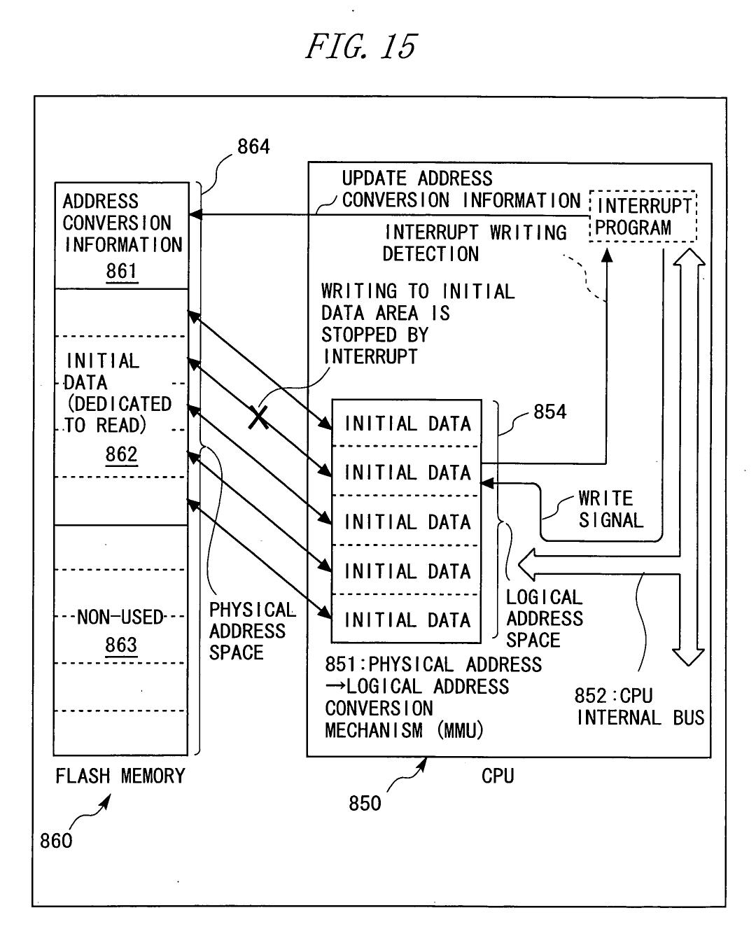

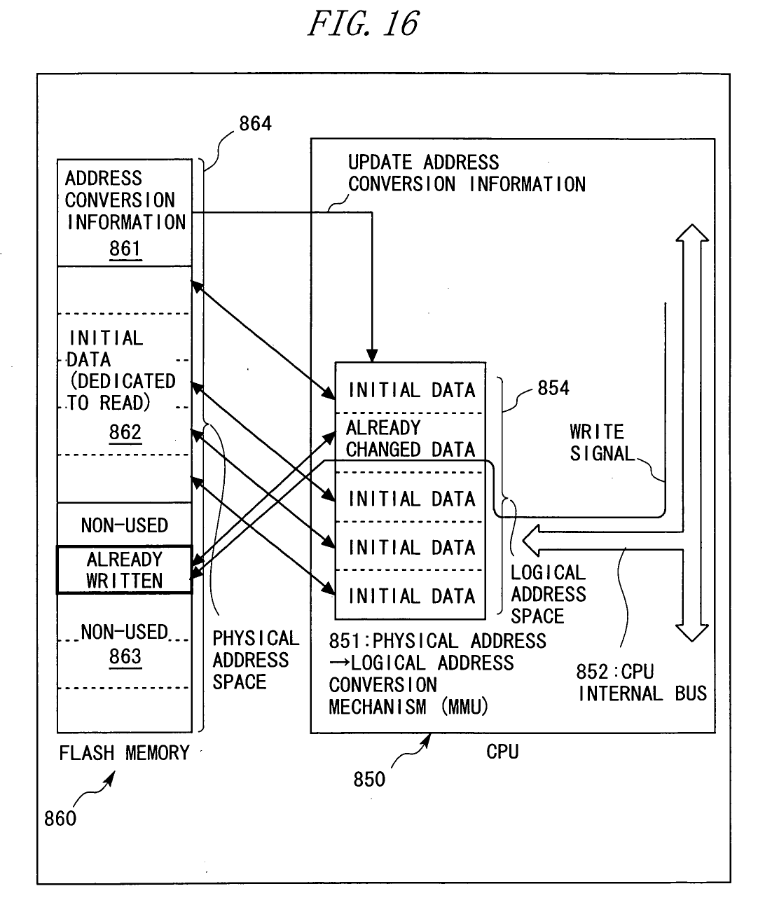

FIG. 15 and FIG. 16 are examples of the writing operation. FIG. 15 shows the operation in the case of the occurrence of the first writing from the initial status (FIG. 14).

If the writing operation occurs in the address mapped to the initial data of the logical address space 854 from the internal bus 852 of the CPU 850, the physical address→logical address conversion mechanism (MMU) 851 generates an interrupt in the CPU.

FIG. 16 shows the process based on the interrupt. In the interrupt process, the physical address→logical address conversion mechanism (MMU) 851 maps the appropriate address conversion information to a non-used area 863 and then carries out the writing operation. For the sector to which the data is written, the address conversion information is changed from 1 to 0, as shown in FIG. 13.

Consequently, the data in which the initial data 862 is changed can be held without rewriting the area of the initial data 862. Also, in the reading process, the physical address→logical address conversion mechanism (MMU) 851 refers to the address conversion information 861.

Then, for the access to the sector to which the data is not written, the physical address→logical address conversion mechanism (MMU) 851 maps to the area of the initial data 862 of the physical address space. Also, for the access to the sector to which the data is written, the physical address→logical address conversion mechanism (MMU) 851 maps to the already-written sector.

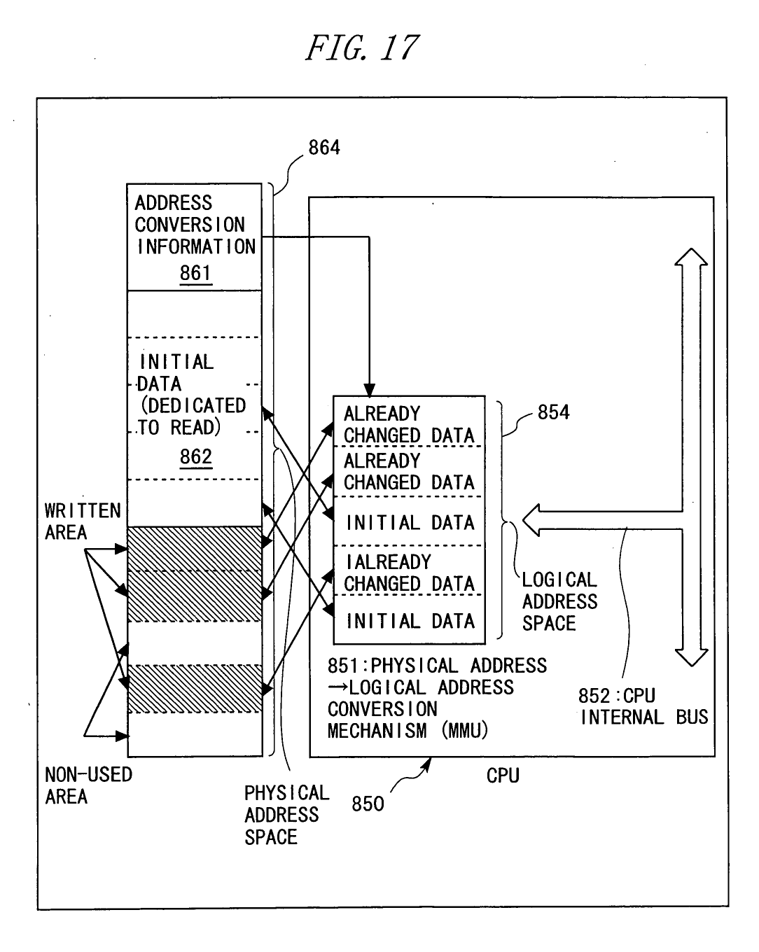

FIG. 17 shows the under-use status where the initial data area and the already-changed data area are mixed. In this way, the physical address→logical address conversion mechanism (MMU) 851 converts the physical address space where the initial data 862 and the already-changed data are mixed, into a current effective data (data arrayed in a sector order in the physical address space).

For this reason, a program to be executed on the CPU 850 reads the initial data 862 while the initial data 862 is not rewritten. Also, when the initial data 862 is rewritten, the program accesses the already-written data.

In this information apparatus, by resetting the address conversion information 861 (setting all to 1 as explained in FIG. 13), it is possible to restore to the initial status in the short time. That is, even in the information apparatus which is shipped after the OS, the application program, and the initial data are stored in the non-volatile memory such as the flash memory and the like, it is possible to restore to the initial status at the time of the factory shipment in the erasure time of the predetermined sector of the flash memory from the status after the usage.

<<Recording Medium which can be Read by Computer and the Like>>

The program which enables any of the functions to be attained in the computer, other apparatuses, machines, and the like (hereafter, the computer and the like) can be recorded in the recording medium which can be read by the computer and the like. Then, the function can be provided by instructing the computer and the like to read and execute the program in the recording medium.

Here, the recording medium which can be read by the computer and the like implies the recording medium which can accumulate the information such as data, a program, and the like through an electric, magnetic, optical, mechanical, or chemical action, and can be read from the computer. In the recording medium, as the medium that can be removed from the computer and the like, for example, there are a flexible disc, a magneto-optical disc, a CD-ROM, a CD-R/W, a DVD, a DAT, an 8 mm tape, a memory card, and the like.

Also, as the recording medium fixed to the computer and the like, there are a hard disc, a ROM (Read Only Memory), and the like.

<<Data Communication Embodied in Carrier Wave>>

Also, the program can be stored in the hard disc and memory in the computer and the like and distributed through the communication medium to a different computer. In this case, the program is transmitted through the communication medium as a data communication signal embodied by using the carrier wave. Then, the function can be provided to the computer and the like which receive the distribution.

Here, the communication medium may be any of: a wired communication medium, for example, a metallic cable type including a coaxial cable and a twist pair cable, an optical communication cable, and the like; or a wireless communication medium, for example, a satellite communication, a ground wave wireless communication, and the like.

Also, the carrier wave is the electro-magnetic wave or light for modulating the data communication signal. However, the carrier wave may be a direct current signal. In this case, the data communication signal may have a base band waveform without any carrier wave. Thus, the data communication signal embodied in the carrier wave may be any of a modulated broad band signal and a non-modulated base band signal (corresponding to the case that the direct current signal of a voltage 0 is used as the carrier wave).

### INDUSTRIAL APPLICABILITY

The present invention can be used in the manufacturing industry of the various information apparatuses, such as a computer, a mobile telephone, a portable terminal, a machine mounted in a car, and the like, and the service industry using the information apparatus.

What is claimed is:

1. A storage control device for controlling a storage device which includes: an initial data storage area for storing an initial data; an updated data storage area for storing an updated data related to the initial data; and a designation area for designating any of the initial data storage area and the updated data storage area as a reading target, the storage control device comprising:
a writing section writing data to the updated data storage area;
a rewriting section rewriting the designation area, in which information for reading the initial data storage area is set at an initial time point, to a setting of reading the updated data storage area, when a writing to the updated data storage area occurs;
an initializing section rewriting the information in the designation area to the setting of reading the initial data;
a selecting section selecting any of the initial data storage area and the updated data storage area to be read when the data is read; and
a reading section reading the updated data storage area or the initial data storage area in accordance with the selection of the selecting section.

2. The storage control device according to claim 1,
wherein in the storage device, the initial data storage area and the updated data storage area are alternately arranged and stored for each predetermined storage unit, and
the reading section reads at least any of the data in the initial data storage area and the data in the updated data storage area which are alternately arranged.

3. The storage control device according to claim 2, wherein the storage device comprises a disc type storage device, and the predetermined storage unit is one or more tracks of the disc.

4. The storage control device according to claim 1, further comprising a logical address managing section relating the initial data storage area and updated data storage area to the same logical address.

5. The storage control device according to claim 1, wherein the storage device has the initial data storage area on a non-volatile semiconductor memory.

6. The storage control device according to claim 1, wherein the storage device has the designation area on a non-volatile semiconductor memory.

7. The storage control device according to claim 1, wherein the storage device comprises a non-volatile semiconductor memory.

8. A storage device comprising:
a storage section which includes an initial data storage area storing an initial data, an updated data storage area storing an updated data related to the initial data, and a designation area designating any of the initial data storage area and the updated data storage area as a reading target;
a writing section writing data to the updated data storage area;
a rewriting section rewriting the designation area, in which information for reading the initial data storage area is set at an initial time point, to a setting of reading the updated data storage area, when a writing to the updated data storage area occurs;
an initializing section rewriting the information in the designation area to the setting of reading the initial data;
a selecting section selecting any of the initial data storage area and the updated data storage area to be read when the data is read; and
a reading section reading the updated data storage area or the initial data storage area in accordance with the selection of the selecting section.

9. A method for controlling a storage device which includes: an initial data storage area storing an initial data; an updated data storage area storing an updated data related to the initial data; and a designation area designating any of the initial data storage area and the updated data storage area as a reading target, the method comprising:
a writing step writing data to the updated data storage area;
a rewriting step rewriting the designation area, in which information for reading the initial data storage area is set at an initial time point, to a setting of reading the updated data storage area, when a writing to the updated data storage area occurs;
a rewriting step rewriting the information in the designation area to the setting of reading the initial data;
a selecting step selecting any of the initial data storage area and the updated data storage area to be read; and
a reading step reading the updated data storage area or the initial data storage area in accordance with the selection in the selecting step.

10. The method for controlling the storage device according to claim 9,
wherein in the storage device, the initial data storage area and the updated data storage area are alternately arranged and stored for each predetermined storage unit, and
the reading step comprises a reading step reading at least any of the data in the initial data storage area and the data in the updated data storage area which are alternately arranged.

11. The method for controlling the storage device according to claim 9, further comprising a step relating the initial data storage area and updated data storage area to the same logical address.

12. A program for causing a computer to control a storage device which includes: an initial data storage area storing an initial data; an updated data storage area storing an updated data related to the initial data; and a designation area designating any of the initial data storage area and the updated data storage area as a reading target, the program comprising:
a writing step writing data to the updated data storage area;
a rewriting step rewriting the designation area, in which information for reading the initial data storage area is set at an initial time point, to a setting of reading the updated data storage area, when the writing step is executed;
a rewriting step rewriting the information in the designation area to the setting of reading the initial data;
a selecting step selecting any of the initial data storage area and the updated data storage area to be read; and
a reading step reading the updated data storage area or the initial data storage area in accordance with the selection in the selecting step.

13. The program according to claim 12,
wherein in the storage device, the initial data storage area and the updated data storage area are alternately arranged and stored for each predetermined storage unit, and
the reading step comprises a reading step reading at least any of the data in the initial data storage area and the data in the updated data storage area which are alternately arranged.

14. The program according to claim 12, further comprising a step relating the initial data storage area and the updated data storage area to the same logical address.
